(19) United States
(12) Patent Application Publication
(10) Pub. No.: US 2012/0096860 A1
(43) Pub. Date: Apr. 26, 2012

(54) Solar energy from the daily natural change in ambient temperature

(76) Inventor: Edwin Steven Newman, Palmdale, CA (US)

(21) Appl. No.: 13/317,286

(22) Filed: Oct. 14, 2011

Related U.S. Application Data
(63) Continuation-in-part of application No. 12/455,639, filed on Jun. 5, 2009.
(60) Provisional application No. 61/572,115, filed on Jul. 12, 2011.

(51) Int. Cl. F03G 6/00

(52) U.S. Cl. 60/641.8

(57) ABSTRACT

Water tends to expand in volume when heated up and contract in volume when heat is taken out of it. This invention relates to systems where solar energy causes pressure changes in water occupying fully a rigid closed container. Pressure energy is allowed to escape the container in a controlled way to operate a reaction turbine and shafted D.C. generator to produce electrical energy.

This invention is a continuation-in-part of utility application Ser. No. 12/455,639 filed Jun. 5, 2009. Reference is also made to Provisional Patent application No. 61/572,115 filed Jul. 12 2011.

### BACKGROUND OF THE INVENTION

a. Field of the Invention

This invention relates to solar energy systems which generate electricity and more specifically passive solar thermal-electric systems which do not concentrate the energy of sunlight.

b. Description of the Prior Art

In central tower solar thermal systems solar energy is made to artificially heat up a fluid which is then made to operate a gas turbine and generator. Whether solar thermal or photovoltaic systems are used to generate electricity the system efficiency is rather low. Also, certain substances when alternaly pressurized and depressurized convert this change into electricity directly. This is the piezoelectric effect. But the conversion rate is very low. Compressing water produces Pressure energy efficiently. And it is possible to convert pressure energy into electrical energy in an efficient way.

In my U.S. Pat. No. 6,781,253 sea water is compressed and decompressed according to wave action offshore. The resulting pressure Variations are transmitted ashore by a pipe. Since water has insignificant internal energy losses this pressure variation is transmitted very efficiently at the speed of sound through seawater. The pressure variation causes a bourdon tube ashore to change shape and activate gearing which in turn is made to operate an electric geherator. But that invention's scope is restricted to a wave energy application.

Since normal temperature variation throughout the day will cause a liquis in a closed and rigid container to be periodically subjected to high pressure, then the object of this invention is to convert the varying pressure energy resulting into electricity efficiently.

### SUMMARY OF THE INVENTION

This invention relates to solar thermal/electric energy conversion systems. A pressure vessel above ground level is operatively connected to a turbine and electric generator located above the pressure vessel. The pressure vessel is completely filled with water at dawn. As the sun increases the temperature of the water the pressure energy of the water is increased. Then the pressure is sufficient a valve is opened and the escaping water is made to operate the turbine and generator, The rising sun increases the pressure of the water as the escaping of the water lowers the pressure of the water. The falling temperature in the afternoon and evening decreases the volume of the water in the pressure vessel.

The attainment of the foregoing and related objects, advantages and features should be more readily apparent to those skilled in the art after reviewing the following more detailed description of the invention, taken together with the drawing in which:

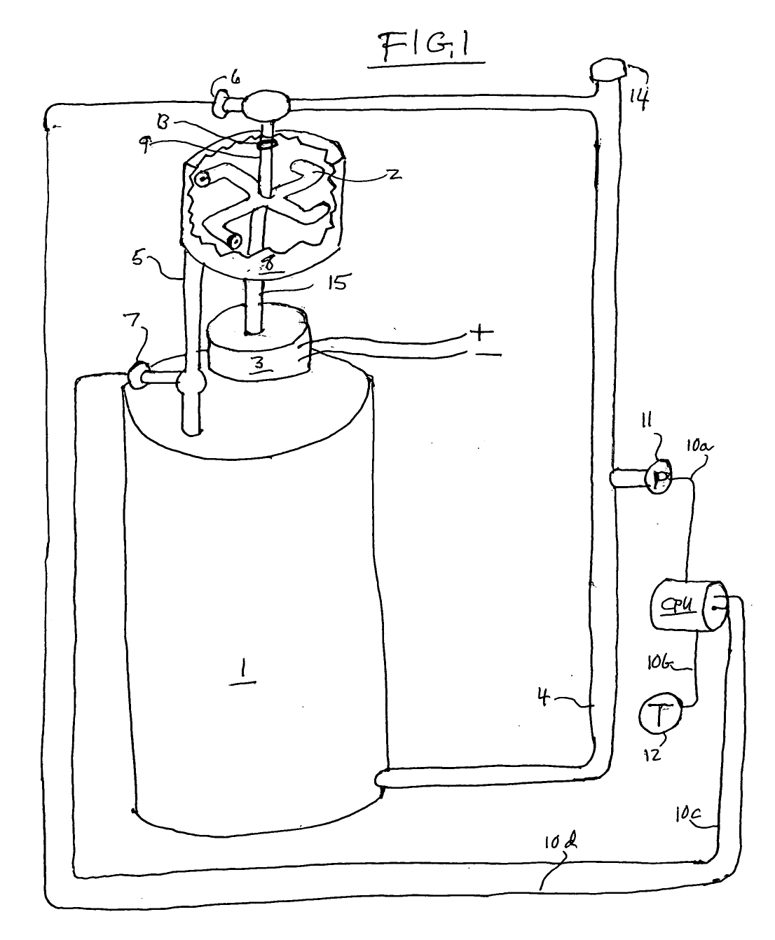

FIG. 1 is a perspective view of the invention, shown without support structure.

### DETAILED DESCRIPTION OF THE INVENTION

Turning to FIG. 1 we see a pressure vessel 1 which is heavily reinforced to remain as rigid as possible under pressure. The operation of the invention can easily develop high pressures within the vessel. Led from the bottom of pressure vessel 1 is pipe 4 which in turn is led to the top of hollow chamber 8 containing turbine 3. Pipe 4 is telescoped over pipe 9. Between pipes 4 and 9 is O-ring 13. Pipe 9 is positioned axially to turbine 2. Fixedly attached to chamber 8 is D.C. Generator 3 which is shafted to turbine 2. The floor of chamber 8 is tilted so water will drain by gravity to a hole led to pipe 5 which operatively connects to the floor of chamber 8 through the top wall of pressure vessel 1. Chamber 8 is large enough to serve as a water reservoir. Valve 7 controls the flow of water through pipe 5 and valve 6 controls the flow of water through pipe 4. Pressure gauge 11 is mounted on pipe 4 and thermometer 12 is mounted on or near the invention. Both gauges 11,12 are made to feed their information to a central processing unit which is made to operate valves 6,7 through the agency of wires 10a-d. Capped fill port 14 is located at the highest point of the invention.

In operation, starting at dawn, water pressure in pressure vessel 1, pipe 4 and residual water within turbine 2 is the lowest over a 24 hour period. Valves 6,7 are closed. As the sun provides heat the temperature and pressure of the water increases. When the pressure of the water is sufficient to operate turbine 2 and generator 3 then valve 6 is opened by action of the CPU based on information from pressure gauge 11 and thermometer 12. On the one hand the waxing sun increases the pressure and temperature of the water and on the other hand as work is done on generator 3 the water becomes cooler and the water pressure tends to drop. As the sun wanes turbine 2 gradually becomes unable to operate generator 3. Just before dawn valve 7 is opened and the spent water within chamber 8 is allowed to drain back into pressure vessel 1 until the vessel is full, then valve 7 is closed.

From the above description it is apparent that the preferred embodiment achieves the objects of the invention. The above embodiment is provided purely as an example. Many other variations, modifications, and applications of this invention may be made. These are considered to be equivalent and within the scope and spirit of the invention.

I claim:

1. A solar energy conversion system comprising:
a. a pressure vessel full of water,
b, a water turbine,
c. an electric generator shafted to said turbine,
d. a chamber within which is said water turbine, and
e. a first pipe operatively connecting said pressure vessel and said water turbine, and a second pipe connecting said pressure vessel with said chamber,
all operatively connected so increasing solar energy will be converted into electrical energy.

2. A method for converting solar energy into electrical energy comprising the steps of:
a. opening a first valve to drain water from a chamber into a pressure vessel at dawn,
b. closing said valve when said pressure vessel is full of water,
c. opening a second valve in a pipe connecting said pressure vessel with a water turbine within said chamber when sufficient pressure has built up in said pressure vessel so pressure energy within said pressure vessel may be made to operate a water turbine within said chamber and a generator shafted to said turbine, and
d. closing said second valve after pressure in said pressure vessel has become ambient.

3. The system of claim 1 wherein to said first pipe is fixedly attached a pressure gauge.

4. The system of claim 1 wherein a thermometer is located near said pressure vessel.

5. The system of claims 3,4 wherein a central processing unit is made to derive information from said pressure gauge and said thermometer and then to operate said first and second valves.
